(19) United States
(12) Patent Application Publication
(10) Pub. No.: US 2010/0039243 A1
(43) Pub. Date: Feb. 18, 2010

(54) Light and sound module

(76) Inventor: Wei-Jei Tuan, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/222,831

(22) Filed: Aug. 18, 2008

(51) Int. Cl. G08B 27/00

(52) U.S. Cl. 340/326

(57) ABSTRACT

A light and sound emitting module coupled to textile comprising: a control unit (1), a switch (2) disposed outside of but triggers the control unit (1); all connects to a printed circuit board (PCB) (11). At least, one light emitting diode (LED) (3) connects to the PCB (11). A speaker (4) disposed outside of the control unit (1) is controlled by the control unit. A pouch (5) is composed of a base (51) and a cover (52) with perimeters (53) sealed by high frequency electromagnetic waves to form a hollow cavity (54) accommodates the control unit (1), the switch (2) and the speaker (4), further the perimeters (53) are coupled on an upper surface of an object (6). Said base and cover are made from polycarbonate or polyvinyl chloride or epoxy. Or the sound and light module molded-to-shape is formed with epoxy or other polymers.

### FIELD OF THE INVENTION

The present invention is related to a sound and light module; particularly, the module is easy to be packed into a textile as a decoration.

### BACKGROUND OF THE INVENTION

Light emission of a module may catch eye sight from walkers-by, but the cool performance depends on the level of street lighting, or intensity of surrounding light. The module can only intermittently emit light to a small audience, who may turn a blind eye to the “always tried and failed” light emissions.

Therefore, persons skilled in the art have provided speaker chip instead of the module for light emission. However, hearing threshold and the ability to localize sound source is not only contrary to what is “to see is to believe”, but a speed of sound is really delivered with a comprehensible message, whether an image is shown is not concerned. Persons could not ignore what is telling or singing or alarming all the way.

Such as U.S. Pat. No. 6,023,516 entitled “Garment with a voice chip in a sealed container” to Steven Rifkind on Feb. 8, 2000 (hereafter Rikind), Rifkind disclosed that a chip coupled to a platform may emit sound within broader frequency responses, which is capable of mimicking human sound or the like. Even the sound chip enclosed inside a pocket of a garment, it will not be destroyed by laundry work.

However, voice chip of Rifkind has drawbacks as following:

1. Although a speaker of Rikind is to be distinguished from others, but a simple sound emission performance for a longer while may be a monotonous sound manipulation repeatedly bombards the hearers with noises. A cheap, but simple, speaker on the voice chip could not arouse user's interest any more.

2. Entire voice chip is ideally designed all-in-one sealed in a water tight case, further the container should accommodates the voice chip and the case to be mounted therein. Shape of the container subject to the content thereinside is already configured to shape an all-in-one chip and case, how can the container occupy space economically? And the unexpected all-in-one chip and case and container with four cornered shape may make users feel uncomfortable.

3. Case accommodates the voice chip all-in-one sealed therein. Thus the case is a little bigger than the all-in-one. Furthermore, when the case is incorporated to the garments or trousers worn next to body, the case may not be suitable worn on body portion with larger curvature.

4. Switch disposed on the case closely proximate to the speaker; patterns formed on the container and the switch are coincided, thus the patterns can keep the switch hidden.

### SUMMARY OF THE INVENTION

Accordingly, the invention is to provide a module that emitting sound and light with a simple switch and can be coupled to the surface of a garment.

A sound and light module comprising: a control unit (1) includes a printed circuit board (PCB) (11), a battery (12) that provides power is disposed below the PCB (11) and an integrated circuit (IC) processor (13) is disposed above the PCB (11), all components as above are enclosed inside a plastic housing (14); a switch (2) disposed outside of the control unit (1) is connected to the PCB (11), the switch triggers the control unit (1); at least, one light emitting diode (LED) (3) connected to the PCB; a speaker (4) connected to the PCB (11) is disposed outside of the control unit (1) and controlled by the control unit (1); a pouch (5) that is watertight and pervious to light, assembled by a soft polycarbonate (PC) or polyvinyl chloride (PVC) base (51) and a soft PC or PVC cover (52) with surface decoration patterns; both perimeters (53) of the base (51) and the cover (52) are sealed by high frequency electromagnetic waves and forms a hollow cavity (54) to accommodate the control unit (1), the switch (2) and the speaker (4) fixed inside, then the sealed perimeters (53) are coupled to an upper surface of an object (6).

The sound and light module of claim 1 wherein a protecting cover (41) has, at least, one opening, is placed on top of an output terminal of the speaker (4); a positioning hole (511) of the pouch (5) accommodates the switch (2) mounted inside a head portion of the pouch, and a cover (21) on top of the switch (2) completely covers up the positioning hole (511) allow the switch (2) stay safe.

The sound and light module of claim 1 wherein said plastic housing (14) is molded-to-shape and assembled by a front housing (15) and a back housing (16) corresponding to the front housing (15).

The sound and light module of claim 1 wherein the components may bind together by epoxy injection first to wrap over and then the injected epoxy is solidified as said rigid plastic housing (14).

The sound and light module of claim 1 wherein said pouch (5) is filled with nitrogen or inert gas (9) to inflate the cover (52) therefore the pouch (5) can absorb shocks.

The sound and light module of claim 1 wherein concentration of the nitrogen or inert gas (9) in the pouch (5) in comparison with ambient air is preferably in the range from 30% up to 70%.

The sound and light module of claim 1 wherein the control unit (1), the switch (2) and the speaker (4) coupled to the base (51) by fast cure adhesive (8).

The sound and light module of claim 1 wherein perimeters of the pouch (5) coupled to the upper surface of the object (6) by one of the following methods: high frequency electromagnetic waves or stitching.

The sound and light module of claim 1 wherein a ball-rolling switch in the control unit (1) connected to the PCB (11) is activated by the switch (2).

The sound and light module of claim 1 wherein said object (6) can be one of the following: garments, pants, hat, backpack, shoes and gloves; said LED (3) can be one of the following: LED, surface mounted device (SMD) LED. Said pouch (5) can be made from PC, PVC, or epoxy.

The sound and light module of claim 1 wherein a head portion of said pouch (5) on top of said switch printed with indicator words (55).

### ADVANTAGES OF EMBODIMENTS OF THE INVENTION

The advantages and benefits can be achieved by embodiments of the present invention as following:

1. With said LED (3) and said speaker (4), said pouch (5) of the present invention first emits sound to attract more attention than usual, and then emits light to catch eyesight and show a location of the user. On the whole, presence of both visual and audible sensual stimuli to the consumers may be used longer than others to be a cost-effective and an extended life kit.

2. Said pouch (5) is an optimal design for separate said control unit (1), said switch (2) and said speaker (4). Variable shapes of said pouch (5) can be shaped to meet the need of market requirements. Decoration style and features of the pouch (5) go with most clothing of users. Due to the switch and the patterns on the cover (51) are not coincided, users can operate the pouch (5) easily without interference invoked between the patterns and the switch. Furthermore, reorient or relocate the speaker (4) to proper locations inside the pouch (5) according to the patterns.

3. Main components of the pouch (5) are separated from one another, or they collectively clog up space inside the pouch (5), that may cause discomfort feelings, when said pouch (5) on the clothing worn next to user's body. Said pouch (5) has a customized contour, due to the pouch may be adjustable with exaggerated curvatures. Moreover, since the main components can be independently retained, maintained and replaced, the pouch is light weight, and material cost can be saved.

4. Main components are added to the base (51) by fast cure adhesive (8). The components will not drift out of place by gravity. Even the pouch (5) is bent or folded up; the components will not be damaged.

5. Because the components are separated from the control unit (1), but controlled by the control unit (1). Such as light effects, colors of the LEDs, or sound effect of the speaker are demanded increased to the pouch (5), for example, only IC of the control unit (1) is necessarily to be changed.

### BRIEF DESCRIPTION OF THE DRAWINGS

FIG. 1: is a perspective view of the pouch of the present invention.

FIG. 2: is an exploded view of the pouch of the present invention.

FIG. 3: is a cross sectional view according to the line III-III of FIG. 1.

FIG. 4: is a cross sectional view of an alternative embodiment of FIG. 3.

FIG. 5: is an exploded view of another control unit.

FIG. 6: is a cross-sectional view of FIG. 5.

FIG. 7: is a diagrammatic view of wiring diagram of the present invention.

FIG. 8: is a schematic view of the module on garments.

FIG. 9: is an enlarged view of the module of FIG. 8.

FIG. 10: is a perspective view of the pouch printed with indicator words.

FIG. 11: is a cross sectional view according to line XI-XI of FIG. 8.

### DETAIL DESCRIPTION OF THE PREFERRED EMBODIMENT OF THE PRESENT INVENTION

The description is described in detail according to the appended drawings hereinafter.

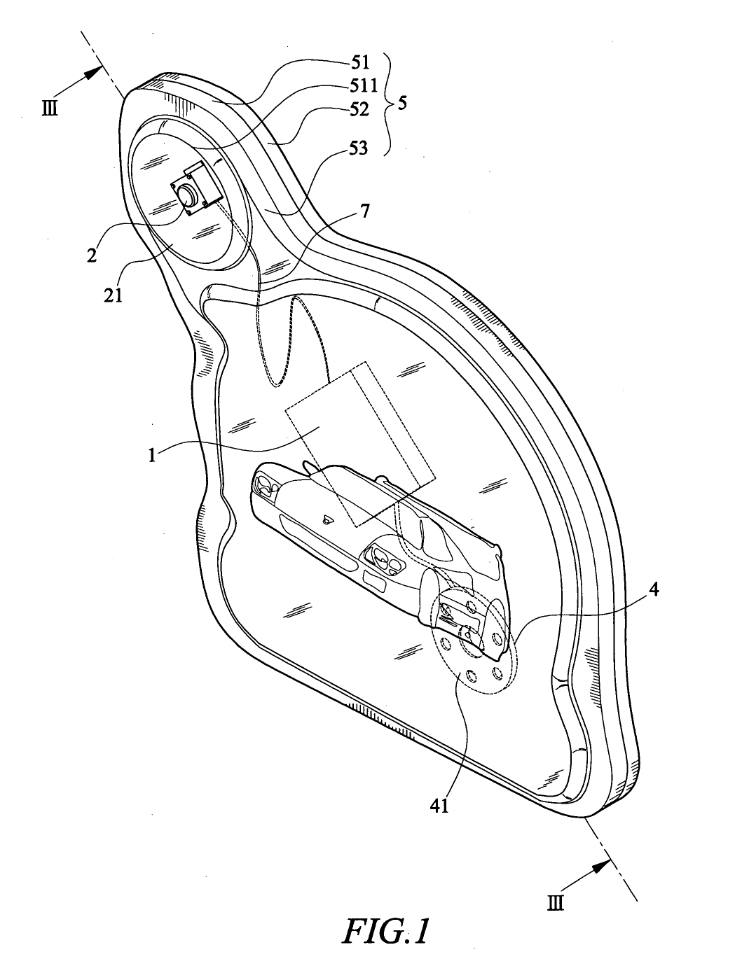

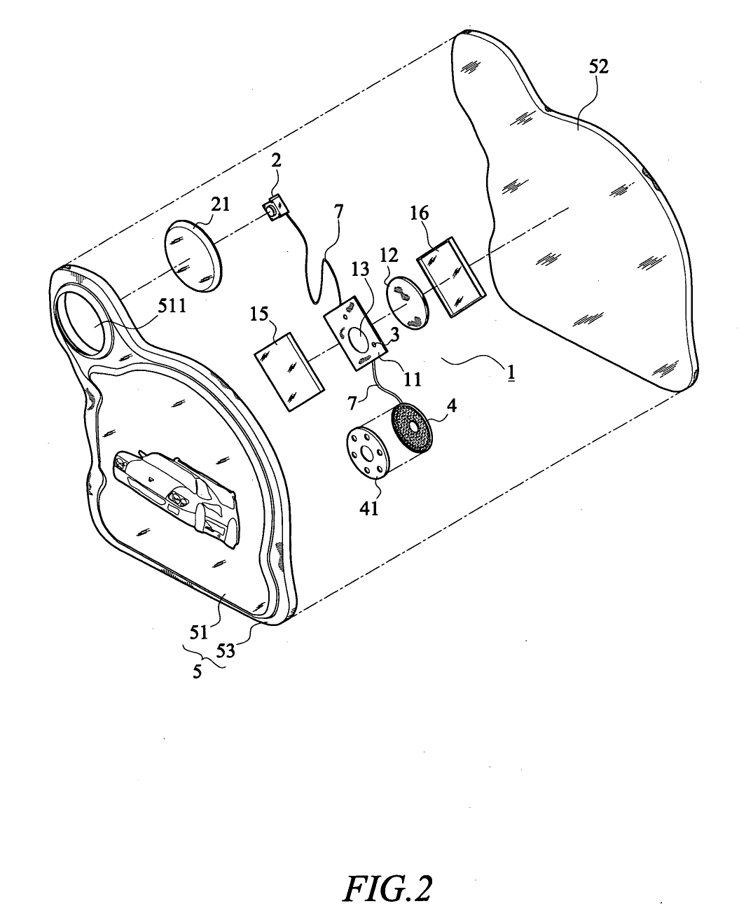

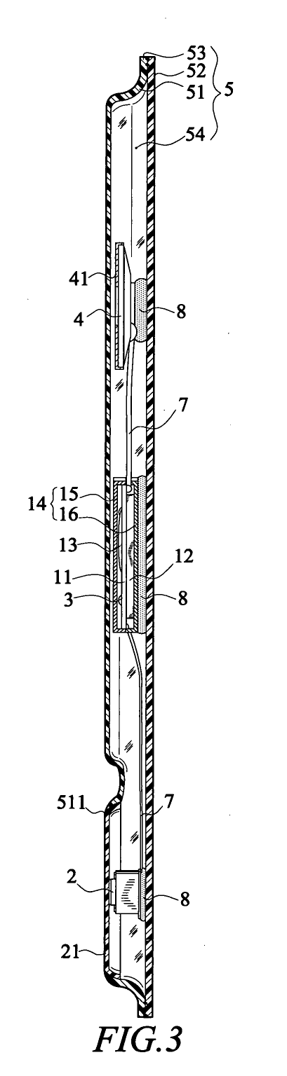

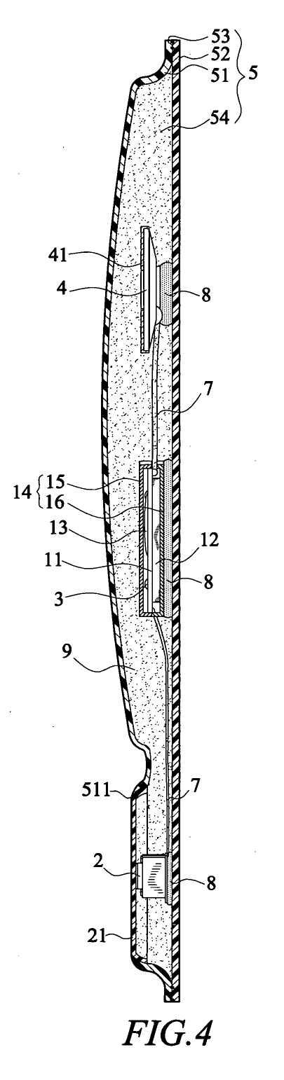

As shown in the FIGS. 1˜7, a light and sound emitting module, comprising:

A control unit (1) that includes a printed circuit board (PCB) (11), a battery (12), which provides power, is disposed below the PCB (11); an integrated circuit (IC) processor (13) is disposed above the PCB (11); all components as above are enclosed inside a plastic housing (14). Or the sound and light module molded-to-shape is formed with epoxy or other polymers. A switch (2) disposed outside of the control unit (1) is electrically connected to the PCB (11); the switch (2) triggers the control unit (1).

At least, one light emitting diode (LED) (3) electrically connected to the PCB (11) is disposed to the control unit (1). A speaker (4) electrically connected to the PCB (11) is disposed outside of the control unit (1) but still controlled by the control unit (1). A pouch (5) is formed by injected polymers, that is, said pouch (5) is formed by a soft base (51) and a soft cover (52). A surface of said cover (52) is formed with patterns. Both said cover (52) and said base (51) are made from either polycarbonate (PC) or injected or heat seal molded polyvinyl chloride (PVC) or epoxy. Both perimeters (53) of said base (51) and said cover (52) are sealed tightly by high frequency electromagnetic waves to form a hollow cavity (54) to accommodate the control unit (1), the switch (2) and the speaker (4) fixed inside the hollow cavity (54), then the sealed perimeters (53) are coupled to an upper surface of an object (6).

Since the control unit (1), the switch (2) and the speaker (4) are separated from one another, but not incorporated into an all-in-one chip inside a conventional case. As a result, the pouch (5) can be shaped with variable shapes in use. Meanwhile, the switch (2) and patterns of said cover (52) are not coincided; said patterns are formed on top of an output terminal of said speaker (4). The switch is therefore operated under control without interference produced by user neither being rushed into operation nor being confused by the patterns. Thereby, locations of the speaker (4) can be selectively arranged anywhere inside the pouch (5), except the head portion where the switch is located. Further, it can be indicated and depicted by the patterns to show how the speaker working out sound effects, when the speaker (4) sounds.

Moreover, the control unit (1), the switch (2) and the speaker (4) are separated from one another can reduce so called “four cornered” shape of said conventional case. Not only material cost is saved, but a light weight pouch (5) shows feasible curvature.

In addition, said control unit (1) can be separately made adjustments, such as IC processor (13) can be adjusted, or the LEDs (3) can be replaced, the light effects, colors of the LEDs (3), or sound effects of the speaker (4) can be altered. All adjustments shall not influence the switch (2) and the speaker (4), since each of them separated from the control unit, each of them can be retained or maintained or replaced independently. Variable shapes of said pouch (5) can be achieved; both light and sound effects can be performed as usual, only said control unit (1) is necessarily adjusted as demanded. For example, IC of the control unit (1) can be replaced.

Perimeters (53) of said base (51) and said cover (52) are heat sealed tightly by high frequency electromagnetic waves; water vapor or moisture could not seep through the upper surface of the object (6) into the pouch (5). In the pouch (5), those components do not smell damp and musty.

A porous cover (41) of the speaker (4) formed with, at least, an opening protects said output terminal of the speaker (4) from damages and impacts. A positioning hole (511) formed through a head portion of the pouch (5) is corresponding to the switch (2). A cover (21) that heat seal with soft PC or PVC base (51) around the perimeters of the hole (511) and on top of the switch (2), said cover (21) fit snugly into the positioning hole (511) covers up the switch (2).

On one hand, with said porous cover (41) and said cover (21), the switch (2) and the speaker (4) can be secluded from collision exerted by external force respectively.

On the other hand, the cover (21) facilitates user's pressing onto the switch (2) promptly; the cover (21) also wards off direct impact from external force to prolong product life cycle of the switch (2).

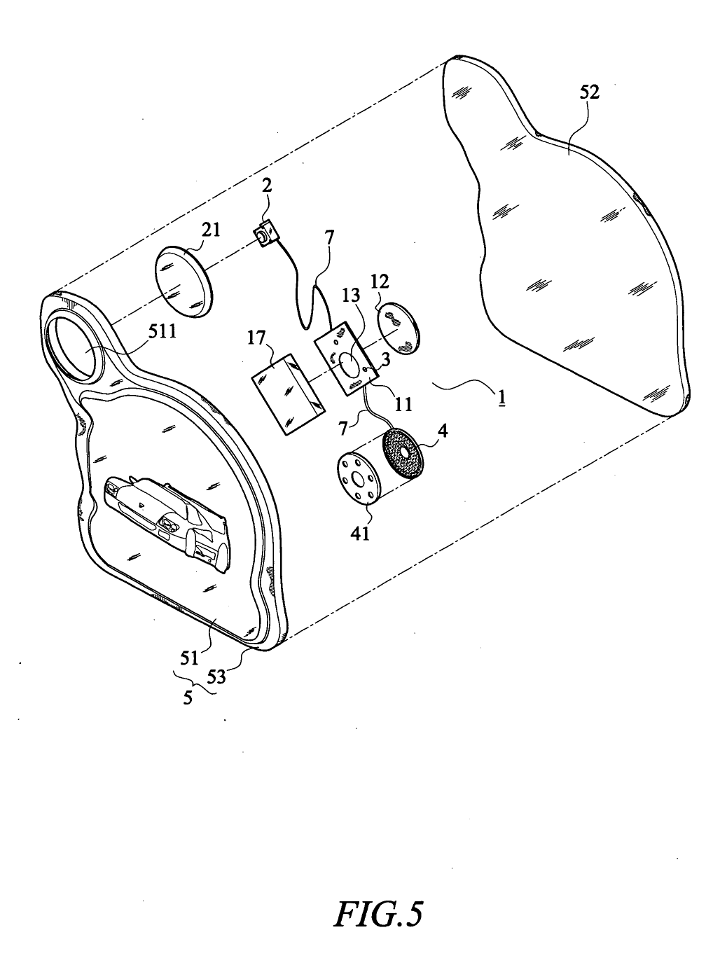

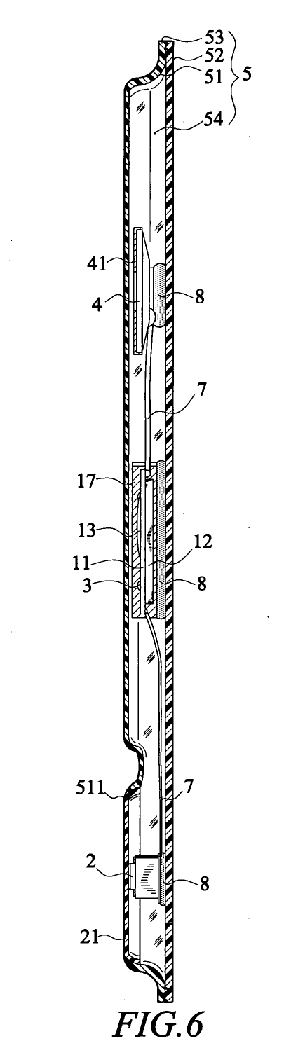

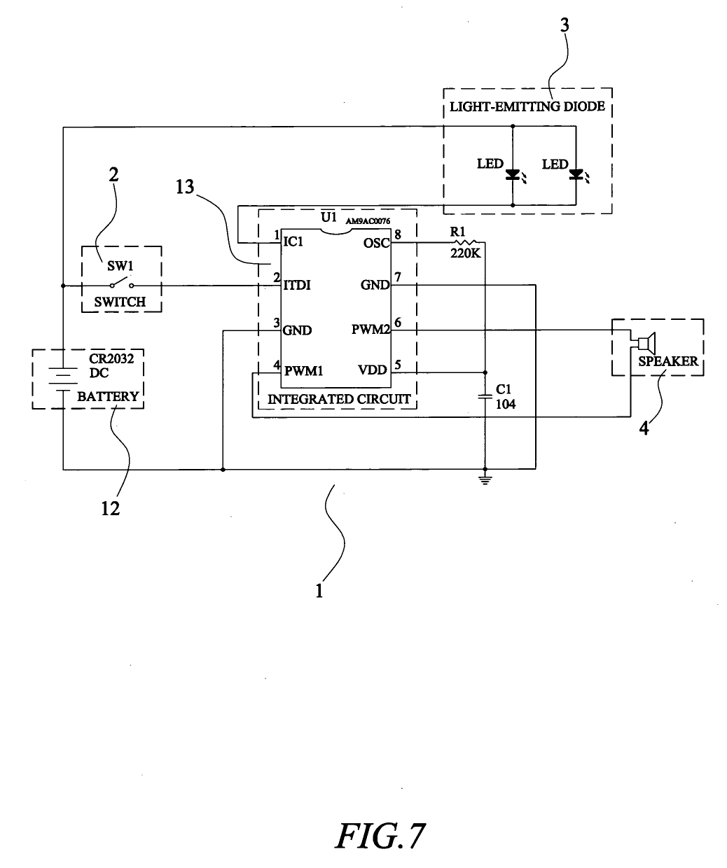

Besides, acoustic resonance would be properly matched by said porous cover (41) so that it makes the sound louder and clearer. The speaker (4) is therefore to be designed more compact than ever, power consumption can be reduced. Increment on intensity and duration and performance capacity of the speaker (4) helps retain messages, songs, with sound effect. That may be technologically feasible and economically reasonable for users to select such a speaker contained inside the pouch (5) of the present invention. At least, duration of usage can be prolonged as the power consumption largely reduced. Said plastic housing (14) is molded-to-shape with a front housing (15) relative to a back housing (16). With watertight adhesive spread on the perimeters of front housing (15) and back housing (16) opposite to each other then assembled by adhesive, or by high frequency electromagnetic waves. The components may bind together by injection of epoxy first to wrap over and then solidify the adherence with the components. That is, the sound and light module molded-to-shape is formed with epoxy or other polymers. The components may bind together by epoxy injection first to wrap over and then the injected epoxy is solidified as said rigid plastic housing (17). (as shown in FIGS. 5-6)

Said pouch (5) also can be filled with nitrogen or inert gas (9), thus the soft PC or PVC cover (52) to be inflated will not wrinkle. Also the inflated pouch (5) can slow down violent collision. Concentration of said nitrogen or inert gas may fill the pouch in comparison with ambient air from 30% up to 70%.

After the pouch (5) filled with nitrogen or inert gas as above, the pouch (5) is therefore provided with an avoidance of collision effect. While the pouch (5) is filled with nitrogen or inert gas less than 30%, all the components inside the pouch are exposed to direct collision exerted by external force. When the nitrogen or inert gas filled over 70% in comparison with ambient air inside the pouch (5), degrees of expansion to the soft PC or PVC cover (52) may come to the end of endurance to the inflated pouch (5), which is easy to be deformed out of shape. Nitrogen or inert gas filled inside the pouch is therefore preferably in comparison with ambient air in the range from 30% up to 70%.

As above, said control unit (1), said switch (2) and said speaker (4) are adhered to the soft PC or PVC base (51) by fast cure adhesive (8).

Inside the pouch, all components will not be slid out of place by gravity. Further, the pouch (5) can bend or even twist without causing collisions among the components. It alleviates break down ratio to the pouch (5).

Since all components separately adhered to the soft PC or PVC base (51), which is further sealed inside the pouch (5); therefore, said pouch (5) can absorb shocks to reduce discomfort feeling of the user in case of the pouch is worn next to body.

Furthermore, said fast cure adhesive (8) is a high-bond adhesive selected from one of the following: heat melting glue, acrylate adhesive, silicone.

Perimeters of said pouch (5) coupled to the upper surface of the object (6) by means of one of the following: high frequency electromagnetic waves, sewing. Such as clothing made of nylon coupled with said pouch by high frequency electromagnetic waves, while clothing made from velvet or wool by sewing.

Inside said control unit (1), a ball-rolling switch (not shown) is electrically connected to said PCB (11). When the switch (2) is activated, operations of said control unit (1) are determined by said ball-rolling switch. Said ball-rolling switch interrupts operations of said switch to emit light intermittently and to reduce power consumption. Product life cycle is prolonged.

Garments, trousers, caps, packs, even the teddy bear, spandex knee support, arm support, gloves can be adorned with the pouch (5).

Said LEDs (3) can be one of the following: LEDs, surface-mount device (SMD) LEDs to enhance light emissions with variable changes.

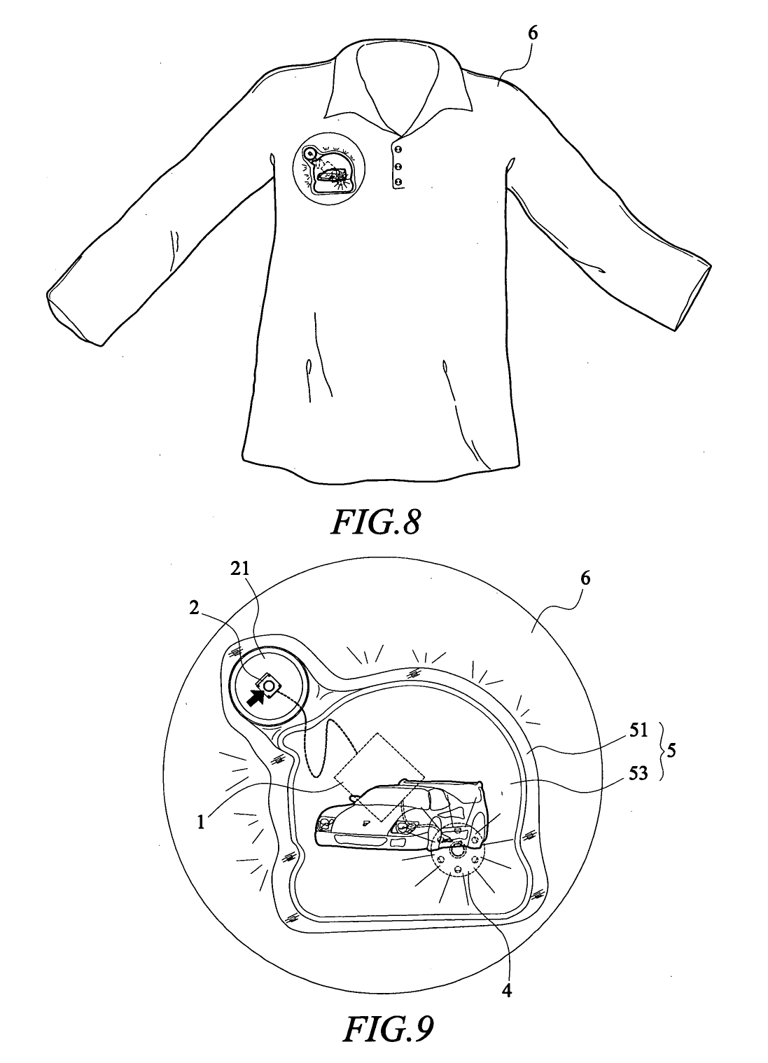

As shown in FIGS. 8˜9, when the pouch (5) applied to clothing, said switch (2) is obviously seen on the clothing. Further all the components inside the pouch (5) are separately designed and coupled to the base (51); the pouch (5) can be printed with variable patterns on the cover. Not only catch sights of audience, but said LEDs (3) and said speaker (4) emit light and sound to arouse interest of audience.

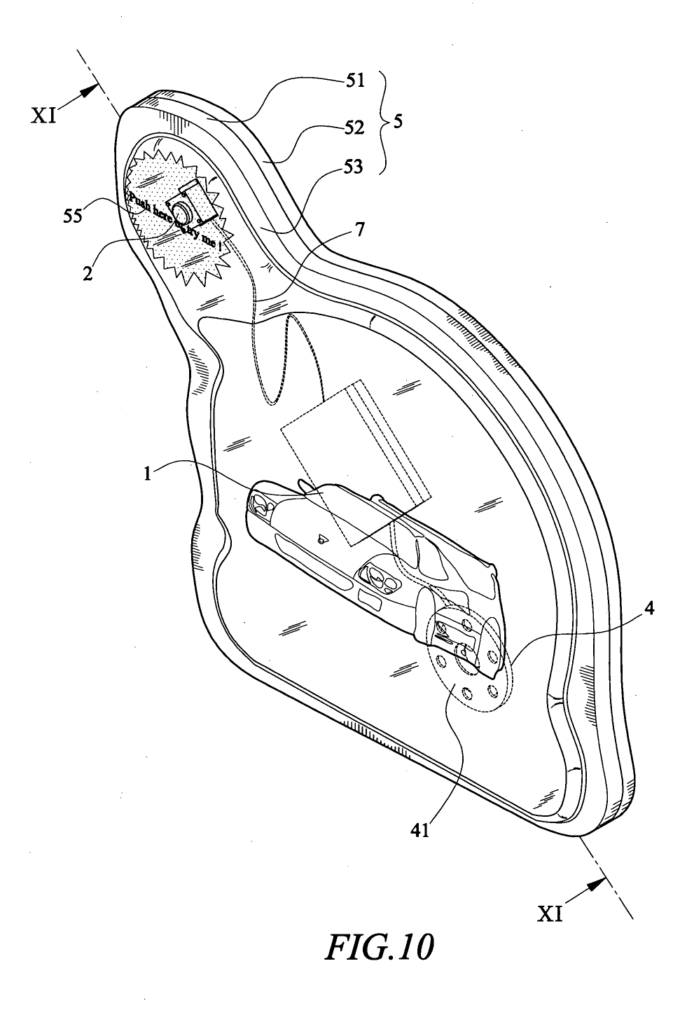

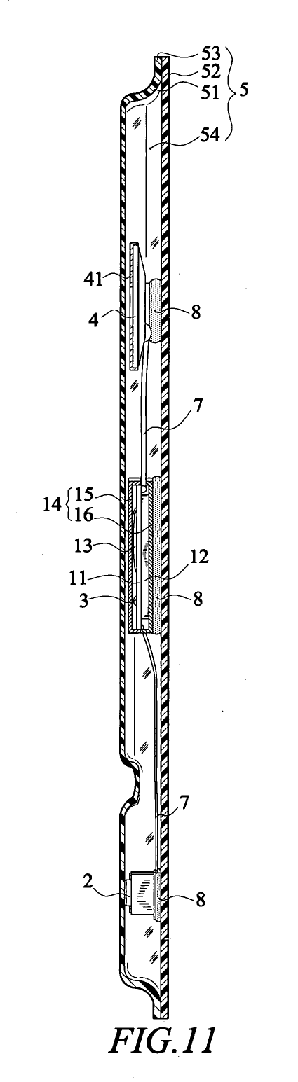

As shown in FIGS. 10-11, the pouch (5) can be simplified as the switch disposed inside the head portion of the pouch, where the positioning hole (511) and the cover (21) can be omitted. Thus, the pouch (5) can be integrally manufactured with an enhanced strength.

In addition, indicator words such as “push here or try me” can be printed on the top portion. It facilitates the spontaneous and responsive activation of the components, as the switch is located on the head portion; the indicator words provide the prima facie appeal.

What is claimed is:

1. A sound and light module comprising: a control unit (1) includes a printed circuit board (PCB) (11), a battery (12) that provides power disposed below the PCB (11) and an integrated circuit (IC) processor disposed above the PCB (11), all components as above are enclosed inside a plastic housing (14); at least, one light emitting diode (LED) (3) is electrically connected to the PCB (11); a pouch (5) that is assembled by a soft polycarbonate (PC) base (51) and a soft PC cover (52) with surface decoration patterns; both perimeters (53) of the base (51) and the cover (52) are sealed by high frequency electromagnetic waves and forms a hollow cavity (54) then the sealed perimeters (53) is coupled to an upper surface of an object (6) characterized in that: a switch (2) disposed outside of the control unit (1) is electrically connected to the PCB (11) to trigger the control unit (1); a speaker (4) disposed outside the control unit (1) is electrically connected to the PCB (11) and controlled by the control unit (1); said hollow cavity (54) accommodates the control unit (1), the switch (2) and the speaker (4) fixed inside.

2. The sound and light module of claim 1 wherein an output terminal of the speaker (4) has a protecting cover (41) with, at least, one opening on top of the speaker; the pouch (5) has a positioning hole (511) relative to the switch (2), and a cover (21) that heat seal with soft PC base (51) around the perimeters of the hole (511) and on top of the switch (2).

3. The sound and light module of claim 1 wherein said plastic housing (14) is molded-to-shape with a front housing (15) corresponding to a back housing (16); or the sound and light module molded-to-shape with epoxy or other polymers.

4. The sound and light module of claim 1 wherein the components may bind together by epoxy injection first to wrap over and then the injected epoxy is solidified as said rigid plastic housing (17).

5. The sound and light module of claim 1 wherein said pouch (5) is filled with air (9) to inflate the cover (52) therefore the pouch (5) can absorb shocks.

6. The sound and light module of claim 1 wherein concentration of a nitrogen or inert gas (9) filled in the pouch (5) in comparison with ambient air is in the range from 30% up to 70%.

7. The sound and light module of claim 1 wherein the control unit (1), the switch (2) and the speaker (4) coupled to the base (51) by fast cure adhesive (8).

8. The sound and light module of claim 1 wherein perimeters of the pouch (5) coupled to an upper surface of the object (6) by one of the following methods: high frequency electromagnetic waves or sewing.

9. The sound and light module of claim 1 wherein a ball-rolling switch in the control unit (1) is electrically connected to the PCB (11) activated by the switch (2).

10. The sound and light module of claim 1 wherein said the object (6) is one of following items: garments, trousers, caps, packs, socks and gloves;

11. The sound and light module of claim 1 wherein said the LED (3) can be one of the following: LED, surface mount device (SMD) LED.

12. The sound and light module of claim 1 wherein said pouch (5) that is assembled by a soft injected or heat seal molded polyvinyl chloride (PVC) base (51) and a soft injected or heat seal molded PVC cover (52) with surface decoration patterns.

13. The sound and light module of claim 1 wherein said pouch (5) made from epoxy.

14. The sound and light module of claim 2 wherein said output terminal of the speaker (4) has said protecting cover (41) with, at least, one opening on top of the speaker; but said positioning hole (511) and said cover (21) on top of the switch (2) can be omitted; while indicator words “push here or try me” printed on a head portion of said pouch (5).
